(19) United States
(12) Patent Application Publication
(10) Pub. No.: US 2021/0382261 A1
(43) Pub. Date: Dec. 9, 2021

(54) Infrared Zoom Illuminating Device

(71) Applicant: Saga Optics Co., Limited, Zhejiang (CN)

(72) Inventor: Hsi Kung Lee, New Taipei City (TW)

(73) Assignee: Saga Optics Co., Limited

(21) Appl. No.: 17/303,495

(22) Filed: May 31, 2021

(30) Foreign Application Priority Data
Jun. 4, 2020 (CN) 202021001050.9

(51) Int. Cl. G02B 7/02; G02B 15/14

(52) U.S. Cl. CPC G02B 7/022; G02B 15/14; G02B 7/021

(57) ABSTRACT

An infrared zoom illuminating device includes a lens holder, a curvedly-grooved cylinder sleeved on the lens holder, an infrared emitter fixed to the lens holder, a condenser lens group fixed to the lens holder, a protective glass fixed to the lens holder, the condenser lens group located between the infrared emitter and the protective glass, and a first moving lens group and a second moving lens movably connected to the lens holder and arranged between the condenser lens group and the protective glass. The condenser lens group condenses the infrared light emitted by the infrared LED to prevent light loss during zooming process. Straight grooves and curved grooves define moving distance of the first and second moving lens groups to achieve continuous zooming. The limit ring restricts the axial movement of the curvedly-grooved cylinder to ensure the stability of rotation of the curvedly-grooved cylinder.

### BACKGROUND

### Field of the Invention

The present invention relates to a night vision device, and more particularly to an infrared zoom illuminating device.

### Related Prior Art

The infrared illuminator on the infrared night vision device generally cannot zoom, and its disadvantage is that the infrared light emits only at a fixed angle. In theory, the intensity of infrared light reflected by the illuminated object is inversely proportional to the square of the illuminating distance, so the effective distance of the general infrared night vision device is very short. The zoom infrared device means that its emission angle of infrared light can be changed. When an object is illuminated, increasing or reducing the emission angle can increase or decrease the intensity of the infrared light reflected.

There are generally two types of infrared light sources on infrared night vision devices, one is infrared light emitting diode (LED) and the other is infrared laser diode (LD). The advantage of the infrared LD is that the irradiation distance is long, but the disadvantage is that there is a safety hazard, so the infrared LD is generally not used. The advantage of the infrared LED is that it is safe and reliable, but the disadvantage is that its own emission angle is large so that the infrared LED needs an optical lens device to focus light to have a certain irradiation distance.

A China Patent (Publication patent Number: CN 103836450 A) discloses an infrared zoom illuminating device, a control method thereof, and an infrared zoom camera. The device essentially includes: an infrared emitter, a zoom lens group, a lens switching mechanism, a control unit, etc. For this device, it achieves zooming by switching lenses. However, this device is relatively complicated in structure and difficult to be applied to night vision devices. Besides, this device cannot achieve continuous zooming due to the fact that the number of focal lengths is determined from the number of lenses that can be switched. Therefore, such a device cannot meet the requirements of use. China patents CN 101334144 and CN 201232954Y disclose a zoomable lamp, which mainly includes a rear seat, an infrared emitter with a base plate, a lamp body, a lens and other elements. For this lamp, it zooms by manually adjusting the distance between the single lens and the light source to control the light emission angle and adjust the spot size. However, during the zooming process, light leakage and light loss will inevitably occur, and its light efficiency is too low. So, in view of the above situation, it is urgent to develop an infrared zoom illuminating device to overcome the shortcomings in current practical applications.

### SUMMARY

One objective of the present invention is to provide an infrared zoom illuminating device to solve the above-mentioned problems proposed in the related art.

In order to achieve the above purpose, the present invention provides the following technical solutions:

An infrared zoom illuminating device comprises a lens holder and a curvedly-grooved cylinder, the curvedly-grooved cylinder is sleeved on an outer surface of the lens holder, a bottom end of the lens holder is disposed with an infrared emitter, a condenser lens group is disposed to the lens holder, a protective glass is disposed to the lens holder, the condenser lens group is located between the infrared emitter and the protective glass, and a first moving lens group and a second moving lens group that are movably connected to the lens holder are arranged between the condenser lens group and the protective glass.

As a further solution of the present invention: two straight grooves are provided on the outer surface of the lens holder.

As a further solution of the present invention: two curved grooves are provided on an outer surface of the curvedly-grooved cylinder, and the curved grooves are nonlinear curved grooves.

As a further solution of the present invention: the first moving lens group and the second moving lens group both include a lens mount in which being disposed a plurality of moving lenses, a top of the moving lenses is provided with a press ring disposed to the lens mount, both left and right sides of the lens mount are provided with a fixing hole in which a pin is inserted, the pin has a first end inserted through and slidably connected with a corresponding one of the straight grooves and a corresponding one of the curved grooves, and a second end that is away from the first moving lens group and the second moving lens group and is sleeved by a copper sleeve.

As a further solution of the present invention: a limit ring is disposed to an outer surface of the lens holder.

Compared with the prior art, the beneficial effects of this invention are:

1. by arranging the condenser lens group, the infrared light emitted by the infrared LED can be condensed, so that there will be no light loss during the zooming process;

2. by forming the straight grooves and the curved grooves, the moving distances of the first moving lens group and the second moving lens group can be effectively controlled to achieve continuous zooming; besides, since the night vision device can control the power of the infrared emitter, the infrared illumination of the night vision device can be controlled comprehensively, which greatly improves the viewing range of the night vision device; and

3. by arranging the limit ring, the axial movement of the curved grooved cylinder can be restricted, so as to ensure the stability of the rotation of the curved grooved cylinder.

### BRIEF DESCRIPTION OF THE DRAWINGS

FIG. 1 is a schematic diagram of the structure of an infrared zoom illuminating device;

FIG. 2 is a schematic diagram of the structure in the infrared zoom illuminating device;

FIG. 3 is a schematic diagram of the structure of the infrared zoom illuminating device;

FIG. 4 is a schematic diagram of the structure of a part of the infrared zoom illuminating device; and

FIG. 5 is a schematic diagram of the structure of a part of the infrared zoom illuminating device.

### DETAILED DESCRIPTION

The technical solution of this patent will be described in further detail below in conjunction with specific embodiments.

The embodiments of this patent are described in detail below. Examples of the embodiments are shown in the accompanying drawings, wherein the same or similar reference numerals indicate the same or similar elements or elements with the same or similar functions. The embodiments described below with reference to the accompanying drawings are exemplary, and are only used to explain the patent, and cannot be understood as a limitation to the patent.

### Embodiment 1

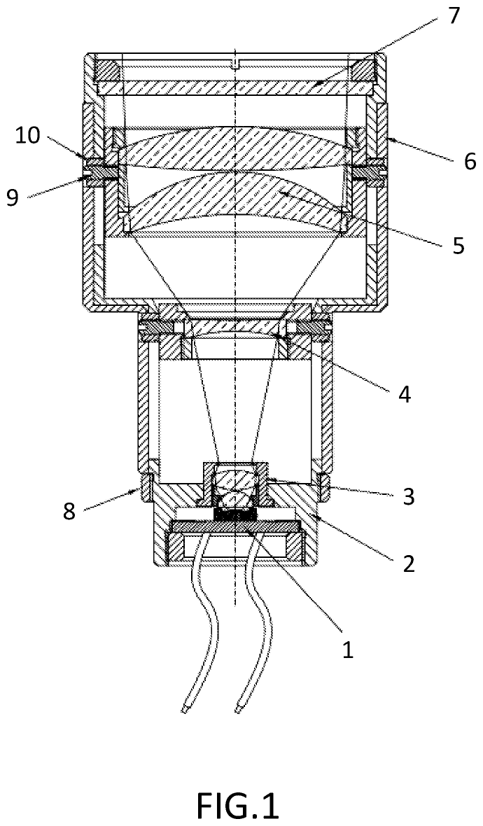

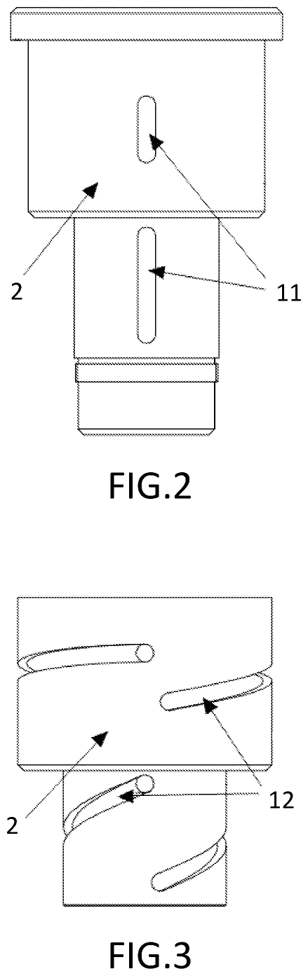

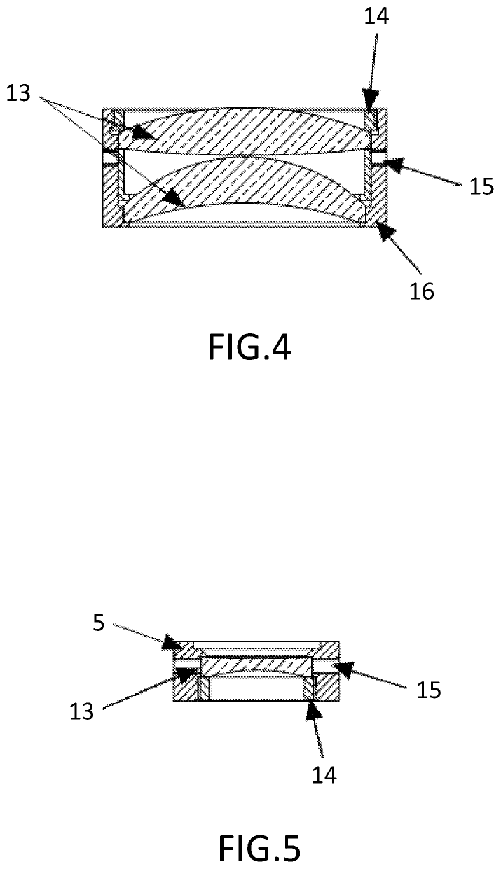

Referring to FIGS. 1-5, in a first embodiment of the present invention, an infrared zoom illuminating device includes a lens holder 2 and a curvedly-grooved cylinder 6 sleeved on an outer surface of the lens holder 2. A bottom end of the lens holder 2 is disposed with an infrared emitter 1, a condenser lens group 3 is disposed to the lens holder 2, a protective glass 7 is disposed to the lens holder 2, the condenser lens group 3 is located between the infrared emitter 1 and the protective glass 7, and a first moving lens group 4 and a second moving lens group 5 that are movably connected to the lens holder 2 are arranged between the condenser lens group 3 and the protective glass 7. By arranging the condenser lens group 3, the infrared zoom illuminating device can condense the infrared light emitted by the infrared LED, so that no light loss occurs during the zooming process.

### Embodiment 2

In this embodiment, two straight grooves 11 are provided on the outer surface of the lens holder 2.

In this embodiment, two curved grooves 12 are provided on an outer surface of the curvedly-grooved cylinder 6, and the curved grooves 12 are nonlinear curved grooves.

In this embodiment, the first moving lens group 4 and the second moving lens group 5 both include a lens mount 16 in which being disposed a plurality of moving lenses 13, and the top of the moving lenses 13 is provided with a press ring 14 disposed to the lens mount 16. Both the left and right sides of the lens mount 16 are provided with a fixing hole 15 in which a pin 9 is inserted. The pin 9 has a first end inserted through and slidably connected with a corresponding one of the straight grooves 11 and a corresponding one of the curved grooves 12, and a second end that is away from the first moving lens group 4 and the second moving lens group 5 and is sleeved by a copper sleeve 10. By the arrangement of the straight grooves 11 and the curved grooves 12, it can effectively control the displacement distances of the first moving lens group 4 and the second moving lens group 5 to achieve continuous zooming. Moreover, since the night vision device can control the power of the infrared transmitter, the infrared illuminating on the night vision device can therefore be controlled comprehensively, which greatly improves the viewing range of the night vision device.

In this embodiment, a limit ring 8 is disposed to the outer surface of the lens holder 2. By the arrangement of the limit ring 8, the axial displacement of the curvedly-grooved cylinder 6 can be restricted, thereby ensuring the stability of rotation of the curvedly-grooved cylinder 6.

The infrared zoom illumination device, by the arrangement of the condenser lens group 3, can condense the infrared light emitted by the infrared LED, so that there will be no light loss during the zooming process. By the arrangement of the straight grooves 11 and the curved grooves 12, the infrared zoom illumination device can effectively control the displacement distances of the first moving lens group 4 and the second moving lens group 5 to achieve continuous zooming. Moreover, since the night vision device can control the power of the infrared transmitter, the infrared illuminating on the night vision device can therefore be controlled comprehensively, which may greatly improve the viewing range of the night vision device. By the arrangement of the limit ring 8, the axial displacement of the curvedly-grooved cylinder 6 can be restricted, thereby ensuring the stability of rotation of the curvedly-grooved cylinder 6.

The working principle of the invention is: the curvedly-grooved cylinder 6 is sleeved on the outer surface of the lens holder 2, the first moving lens group 4 and the second moving lens group 5 are both arranged inside the lens holder 2, the pins 9 pass through the curved grooves 12 of the curvedly-grooved cylinder 6 and the straight grooves 11 of the lens holder 2 and are then fixed to the lens mount 16, each of the pins 9 is sleeved by a copper sleeve 10, the infrared emitter 1, the condenser lens group 3 and the protective glass 7 are all fixed on the lens holder 2, and the limit ring 8 of the lens holder 2 can limit the axial movement of the curvedly-grooved cylinder 6 so that the curvedly-grooved cylinder 6 can only rotate; and after such an infrared zoom illumination device is fixed on the night vision device through the lens holder 2, the curvedly-grooved cylinder 6 is rotated to drive the first moving lens group 4 and the second moving lens group 5 to move in the lens holder 2 through the copper sleeve 10 and the pins 9, and with the rotation of the curvedly-grooved cylinder 6, the positions of both the first moving lens group 4 and the second moving lens group 5 can be changed, thereby changing the infrared emission angle.

The above are only the preferred embodiments of the present invention. It should be pointed out that for those skilled in the art, without departing from the concept of the present invention, several modifications and improvements can be made, and these should also be regarded as the protection scope of the invention and will not affect the effect and practicality of the implementation of the invention.

What is claimed is:

1. An infrared zoom illuminating device comprising a lens holder and a curvedly-grooved cylinder, characterized in that:
the curvedly-grooved cylinder is sleeved on an outer surface of the lens holder, a bottom end of the lens holder is disposed with an infrared emitter, a condenser lens group is disposed to the lens holder, a protective glass is disposed to the lens holder, the condenser lens group is located between the infrared emitter and the protective glass, and a first moving lens group and a second moving lens group that are movably connected to the lens holder are arranged between the condenser lens group and the protective glass.

2. The infrared zoom illuminating device as claimed in claim 1, wherein two straight grooves are provided on the outer surface of the lens holder.

3. The infrared zoom illuminating device as claimed in claim 2, wherein two curved grooves are provided on an outer surface of the curvedly-grooved cylinder, and the curved grooves are nonlinear curved grooves.

4. The infrared zoom illuminating device as claimed in claim 1, wherein the first moving lens group and the second moving lens group both include a lens mount in which being disposed a plurality of moving lenses, a top of the plurality of moving lenses is provided with a press ring disposed to the lens mount, both left and right sides of the lens mount are provided with a fixing hole, in which a pin is inserted, the pin has a first end inserted through and slidably connected with a corresponding one of the straight grooves and a corresponding one of the curved grooves, and a second end that is away from the first moving lens group and the second moving lens group and is sleeved by a copper sleeve.

5. The infrared zoom illuminating device as claimed in claim 4, wherein a limit ring is disposed to the outer surface of the lens holder.
